(19) United States
(12) Patent Application Publication
(10) Pub. No.: US 2026/0043476 A1
(43) Pub. Date: Feb. 12, 2026

(54) MECHANICAL PACKING CARTRIDGE HAVING A SPIRAL PACKING ELEMENT FOR USE WITH A FLUID REGULATING DEVICE

(71) Applicant: A.W. CHESTERTON COMPANY, Groveland, MA (US)

(72) Inventors: Joseph K. KALESHIAN, Burlington, MA (US); Philip Michael MAHONEY, JR., Roslindale, MA (US); Henri Vincent AZIBERT, Windham, NH (US)

(21) Appl. No.: 19/295,171

(22) Filed: Aug. 8, 2025

Related U.S. Application Data
(60) Provisional application No. 63/680,953, filed on Aug. 8, 2024.

(51) Int. Cl. F16J 15/18

(52) U.S. Cl. CPC F16J 15/183

(57) ABSTRACT

A mechanical packing cartridge for use with a fluid regulating device to provide a seal between a movable shaft and a stationary housing of the fluid regulating device. The mechanical packing cartridge can include a packing element having a length sufficient to be coiled having a first end and a second end, a first end cap element having a main body having a first top land surface formed in a sloped helical shape for coupling to the first end of the packing element, and a second end cap element having a second top land surface formed in a sloped helical shape for coupling to the second end of the packing element.

### RELATED APPLICATION

The present application claims priority to U.S. provisional patent application Ser. No. 63/680,953, filed on Aug. 8, 2024, and entitled Single Unitary Spiral Packing Element Forming A Sealing Assembly For Use With A Fluid regulating Device, the contents of which are herein incorporated by reference.

### BACKGROUND OF THE INVENTION

The present invention relates to a mechanical packing sealing assembly suitable for use with a fluid regulating device.

There exists in the art many different types of fluid regulating devices, including for example valves, regulators, pumps, differential pressure transducers and the like. Conventional fluid regulating devices, such as valves and pumps, are used in many different types of commercial applications to help regulate the flow of a fluid through a fluid conveyance system. Conventional valves, for example, come in many different shapes and sizes, and can include for example block or gate valves, control valves and the like. When used in commercial applications, the valves typically employ a mechanical packing assembly mounted in stationary equipment that helps reduce fluid loss and the amount of unwanted gaseous emissions that leak or are accidentally emitted from the valve.

The packing material typically includes a plurality of separate packing elements or components that are axially stacked together in a groove formed in the stationary equipment housing (e.g., stuffing box) of the fluid regulating device. The packing assembly is mounted about and contacts a movable shaft so as to form a fluid seal therewith. The length of each of the packing elements is typically calculated and then cut from a roll of packing material that comes in rope form, and the number of packing elements that are needed to be mounted within the equipment also needs to be determined. The individually cut packing elements are then mounted and stacked within the equipment one at a time, with careful attention being paid to the orientation of the end of each ring of packing material. An axially movable gland follower or compression gland can be employed to selectively compress the packing assembly. As the packing assembly is compressed, the packing elements expand radially to create a suitable fluid seal between the shaft and the stationary equipment housing. The seal formed by the packing assembly minimizes fluid leakage and helps maintain a pressure boundary between the process fluid housed within the stationary equipment and the external atmosphere.

An example of a conventional fluid regulating device that mounts a conventional sealing assembly is shown, for example, in FIG. 15. The illustrated fluid regulating device 200 can include a stuffing box or stationary equipment housing 202 that has a groove or channel 204 formed along an inner surface that is sized and configured for mounting a sealing assembly, such as a packing assembly 210. The stuffing box 202 can be mounted about a movable shaft 206. The packing assembly 210 can include a series of packing elements 212 that are mounted and stacked within the channel 204, as is known in the art. According to one conventional embodiment, the channel 204 can be typically sized to accommodate anywhere between three and seven packing elements 212, depending upon the type and size of the fluid regulating device. In the example embodiment, five packing elements 212 are mounted within the channel 204. The fluid regulating device 200 can also include a compression gland element or adjustment mechanism 220 that is coupled to the stuffing box 202 by a series of fasteners 224. The gland element 220 can apply a compressive force to the packing assembly 210 by axially compressing the packing elements so as to ensure sealing contact between the packing assembly 210 and the shaft 206. The forces applied by the gland element 220 can be manually adjusted via the gland element 220.

A drawback of the conventional mounting techniques for the packing elements in conventional fluid regulating devices is that the compression gland element 220 applies a unidirectional force to the packing assembly 200, and the compression forces generated by the gland element 220 are unevenly distributed among and across the axially stacked packing elements 212. Specifically, the axially outboard most packing element 212A that contacts the compression gland element 220 is exposed to higher compressive forces from the gland element 220 than the axially innermost or inboard packing element 212B, which is located opposite the packing element 212A. Similarly, the axially inboard most packing element 212B experiences higher compression forces from the process fluid than the outboard packing element 212A since the packing element 212B is disposed adjacent to the process fluid. Thus, the top or outboard packing element 212A is subjected to the highest compression gland load with minimal exposure to the process fluid pressure, while the bottom inboard packing element 212B is subjected to the least amount of gland load with the highest exposure to the process fluid pressure.

Consequently, an uneven distribution of load versus pressure is generated across the packing elements 212 since the packing rings closer to the gland element are more heavily loaded, thus resulting in higher frictional heat and excessive wear. The inboard packing elements closer to the process fluid are least loaded from the gland element, resulting in a non-uniform wear of the packing elements across the packing assembly.

### SUMMARY OF THE INVENTION

The present invention relates to a unitary mechanical packing cartridge that can include a single spiral braided packing element that is disposed and captured between a pair of helical profiled end cap elements. Each end of the spiral packing element is coupled or attached to each end cap element by a suitable fastener. The spiral orientation of the packing element around the shaft enhances hydrodynamic lubrication and helps pump leakage fluid back into the process fluid based on the spiral orientation of the braid element and the direction of shaft rotation. Various packing materials and cross sections can be used to construct the cartridge assembly.

The end cap elements can have a top land surface on the main body that has an axially oriented helical or spiral slope or pitch that compliments the spiral winding of the packing element. The helical pitch of the top land surface can be disposed so as to be opposite or in the same direction as the rotation of the shaft. The spirally mounted packing element can be attached to the helical top land surface by a suitable fastener that can be configured to secure or fix the terminal ends of the packing element to the top land surface of the end cap elements, thus forming a unitary cartridge.

The present application is directed to a mechanical packing cartridge for use with a fluid regulating device to provide a seal between a movable shaft and a stationary housing of the fluid regulating device, comprising a packing element having a length sufficient to be coiled having a first end and a second end, a first end cap element having a main body having a first top land surface formed in a sloped helical shape for coupling to the first end of the packing element, and a second end cap element having a second top land surface formed in a sloped helical shape for coupling to the second end of the packing element. The main body of first end cap element has a first fastener opening formed therein that is sized and configured for seating a first fastener element for securing the first end of the packing element to the first top land surface, and the main body of second end cap element has a second fastener opening formed therein that is sized and configured for seating a second fastener element for securing the second end of the packing element to the second top land surface.

According to one embodiment, the main body of the first end cap element has a split formed therein to form a first flex region that enables the first end cap element to be mounted about the shaft, and the main body of the second end cap element also has a split formed therein to form a second flex region that enables the second end cap element to be mounted about the shaft. According to another embodiment, the main body of the first end cap element has a side surface that has a plurality of fluid openings formed therein that are sized and configured for passing a fluid therethrough. According to still another embodiment, the main body of the first end cap element has a bottom surface, and wherein the bottom surface has a plurality of spaced apart slits formed therein for providing flexibility to the main body. According to further embodiments, the main body of the first end cap element has a side surface that has an annular groove formed therein that is sized and configured for engaging with an extraction tool.

According to another embodiment, the main body of each of the first and second end cap elements has a groove formed in the top land surface that is sized and configured for mounting a fastener element, and a pair of openings formed in the top land surface that extends through the main body to a bottom surface of the main body. The first end cap element can be differently configured relative to the second end cap element, or the end cap elements can be the same. Optionally, the first end cap element or the second end cap element can have a groove formed in a side surface thereof that is sized and configured to provide a lantern ring effect.

### BRIEF DESCRIPTION OF THE DRAWINGS

These and other features and advantages of the present invention will be more fully understood by reference to the following detailed description in conjunction with the attached drawings, in which like reference numerals refer to like elements throughout the different views. The drawings illustrate principals of the invention and, although not to scale, show relative dimensions.

FIG. 1 is a partial cross-sectional view of a fluid regulating device mounting the mechanical packing cartridge according to the teachings of the present invention.

FIG. 2 is a partial cross-section perspective view of the fluid regulating device of FIG. 1 mounting the mechanical packing cartridge.

FIG. 3 is an isolated perspective view of a first embodiment of the mechanical packing cartridge according to the teachings of the present invention.

FIG. 4 is a perspective view of an end cap element of the mechanical packing cartridge according to the teachings of the present invention.

FIG. 5 is a perspective view of an end cap segment of one of the end cap elements of the mechanical packing cartridge according to the teachings of the present invention.

FIG. 6 is a perspective view of a packing element of the mechanical packing cartridge according to the teachings of the present invention.

FIG. 7 is a partial cross-sectional view of the mechanical packing cartridge showing the fastener employed to secure the packing element according to the teachings of the present invention.

FIG. 8 is a perspective view of the fastener employed in the mechanical packing cartridge according to the teachings of the present invention.

FIG. 9 is an isolated perspective view of a second embodiment of the mechanical packing cartridge according to the teachings of the present invention.

FIG. 10 is a perspective view of an end cap element of the mechanical packing cartridge of FIG. 9 according to the teachings of the present invention.

FIG. 11 is an isolated perspective view of a third embodiment of the mechanical packing cartridge according to the teachings of the present invention.

FIG. 12 is a perspective view of an end cap element of the mechanical packing cartridge of FIG. 11 according to the teachings of the present invention.

FIG. 13 is an isolated perspective view of a fourth embodiment of the mechanical packing cartridge according to the teachings of the present invention.

FIG. 14 is a perspective view of an end cap element of the mechanical packing cartridge of FIG. 13 according to the teachings of the present invention.

FIG. 15 is a partial cross-sectional view of a conventional mounting arrangement of a packing assembly in a fluid regulating device.

### DETAILED DESCRIPTION

The present invention is directed to a mechanical packing cartridge suitable for use with a fluid regulating device for reducing or minimizing fluid leakage therefrom. The mechanical packing cartridge provides sealing forces in an axial and radial direction and can be self-regulating.

As used herein, the term “fluid regulating device” is intended to encompass any selected device that helps, assists, prevents, pumps, or regulates the flow of a fluid through a fluid transport or conveyance medium, such as a pipe or device. The fluid regulating device is preferably of a type that employs one or more packing elements, and can include valves, regulators, pumps, and the like. The fluid regulating device can be mounted to stationary equipment. When a valve is employed, the valves can have any selected size and shape, and can include for example a hydraulic valve, a manual valve, a pneumatic valve, a solenoid valve, a motor valve, a block valve, and the like.

The term “shaft” is intended to refer to any suitable device in a mechanical system to which a mechanical seal or packing elements can be mounted or employed and includes shafts, rods, and other known devices. The shaft can form part of the fluid regulating device or can form part of stationary equipment that is coupled to the fluid regulating device. The shaft can move in any selected direction, such as for example in a rotary direction or in a reciprocating direction.

The terms “axial” and “axially” as used herein refer to a direction generally parallel to the axis of a shaft. The terms “radial” and “radially” as used herein refer to a direction generally perpendicular or transverse to the axis of a shaft. The terms “fluid” and “fluids” refer to liquids, gases, and/or combinations thereof.

The terms “axially inner” or “axially inboard” as used herein refer to the portion of the stationary equipment proximate the stationary equipment and the process fluid. With regard to equipment that mounts packing elements, the direction refers to the packing elements located proximate the process fluid. Conversely, the terms “axially outer” or “axially outboard” as used herein refer to the portion of stationary equipment distal from the process fluid and proximate an ambient environment.

The term “radially inner” as used herein refers to the portion of the system proximate a shaft. Conversely, the term “radially outer” as used herein refers to the portion of the system distal from the shaft.

The term “gland” or “gland element” as used herein is intended to include any suitable structure that enables, facilitates, or assists securing a mechanical seal or packing elements to stationary equipment or a fluid regulating device, while concomitantly surrounding or housing, at least partially, one or more seal components. The gland element can also be configured to move axially to apply a compressive force to a packing assembly having a series of packing elements. If desired, the gland element can also provide fluid access to a mechanical seal. Those of ordinary skill will also recognize that the gland assembly can form part of the mechanical seal assembly, stationary equipment, or fluid regulating device.

The terms “stationary equipment” or “equipment” as used herein is intended to include any suitable stationary structure or housing that surrounds or houses a shaft or rod within which a packing assembly is mounted or to which a gland element or fluid regulating device is secured. The stationary structure can include any type of commercial or industrial equipment such as pumps, valves, and the like. Those of ordinary skill in the relevant art will readily recognize that the gland assembly can form part of the mechanical seal, stationary equipment, or fluid regulating device.

The terms “process medium” and/or “process fluid” as used herein generally refers to a medium or fluid housed within or being transferred through the stationary equipment or fluid regulating device. In pump applications, for example, the process medium is the fluid being pumped through the pump housing.

The term “mechanical seal” as used herein is intended to include various types of sealing assemblies and mechanical seals, including cap seals, single seals, tandem seals, dual seals, concentric seals, gas seals, spiral seals, solid seals, split seals and other known seal types and configurations.

The present invention can employ a mechanical packing cartridge 20 having one or more packing elements 22, including for example a spiral packing element, that is formed of a selected type of packing material. The packing material typically comes in rope form that can be cut to size by the user. The packing element can be wrapped around the shaft and can be seated in between a pair of end cap elements to form the mechanical packing cartridge. The mechanical packing cartridge 20 can be mounted within a stuffing box 16 of a fluid regulating device. The packing element 22 provides a dynamic sealing interface or surface between the shaft 12 and the mechanical packing cartridge 20. The packing element 22 can have any selected shape and size, and can be formed, for example, in an interbraid pattern or a square braid pattern, or any other suitable braiding pattern known to those of ordinary skill in the art. The packing element 22 can be in the form of a braided material that is commonly square or round when viewed in cross section, although the packing element can be provided in a variety of different cross-sectional shapes. Multiple packing elements can be provided in the mechanical packing cartridge in order to provide a seal around the shaft 12. The braided packing element 22 can be formed by braiding together multiple individual packing yarns, typically of the same type of material, along a set of material paths. Further, the packing element 22 can be formed of a packing material that includes one or more yarn components that are disposed within a reinforcing material or structure, such as a wire mesh, to form a packing strand. The packing element 22 can have a main body that has a plurality of side surfaces if a square or rectangular braid. The main body can be optionally coated with any suitable material, such as polytetrafluoroethylene (PTFE), as is known in art. The yarn can be formed of any suitable material and can be formed for example of graphite. Other materials include mica, vermiculite, and polytetrafluoroethylene (PTFE). The wire mesh can be formed of any suitable material, such as metal, examples of which include copper, brass, lead, Inconel, stainless steel, or Monel materials. The packing element can be formed by braiding together individual packing strands or yarns to form the packing element.

One of ordinary skill in the art will readily recognize that the packing material can be formed from multiple different types of materials or packing yarns and can be braided in a symmetrical or asymmetrical manner relative to a lateral or horizontal axis across a cross-sectional face of the packing material. The packing material forming the packing element 22 can be selected for specific applications and to exhibit selected properties. Examples of various types of braids and braiding patterns are shown in U.S. Pat. No. 9,388,903, the contents of which are herein incorporated by reference. Examples of the type of packing elements suitable for use in the packing cartridge of the present invention include the 1400R, 1600, 1601, and 1622 brand packing materials sold by A.W. Chesterton Co., the assignee hereof. Other types of packing materials can also be used. The packing assembly can also include any selected number of packing elements. The packing assembly can also optionally include one or more spacer elements.

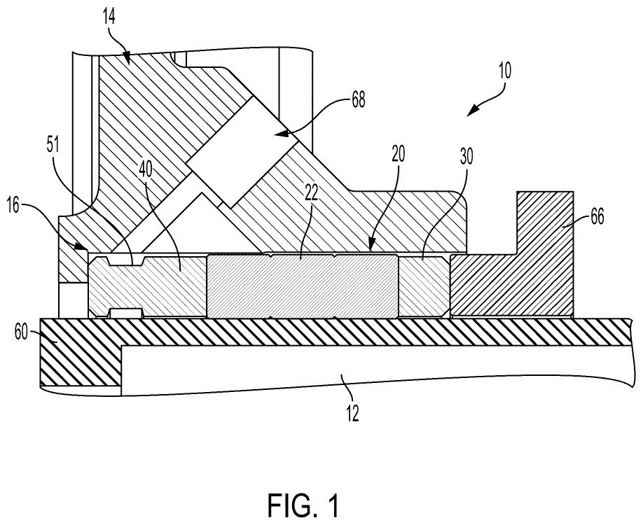

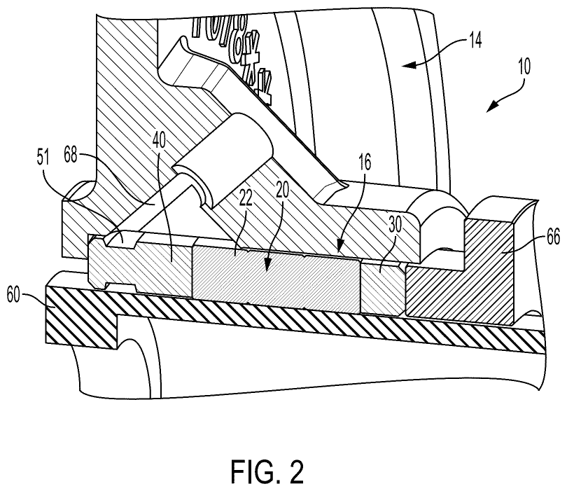

FIGS. 1 and 2 illustrate a fluid regulating device that employs the mechanical packing cartridge 20 of the present invention to form a mechanical sealing system. The illustrated fluid regulating device 10 includes a stationary housing 14 that seats about a movable shaft 12, such as a rotating shaft. The fluid regulating device 10 can be a pump or a valve. The stationary housing 14 can include a stuffing box 16 or dedicated space or groove formed along an inner surface of the housing that is configured for mounting the mechanical packing cartridge 20. The fluid regulating device can also employ an optional sleeve element 66 that can be mounted about the shaft 12 and can rotate therewith. The fluid regulating device further includes an adjustable gland element 66 that is axially movable so as to apply an axial compressive force to the mechanical packing cartridge 20. The stationary housing 14 can also have formed therein a flush port inlet 68 that is configured to be in fluid communication with the stuffing box 16. The flush port inlet enables a flushing fluid from a suitable external fluid source to be passed through the stationary housing and to the interior of the device, such as to the mechanical packing cartridge 20.

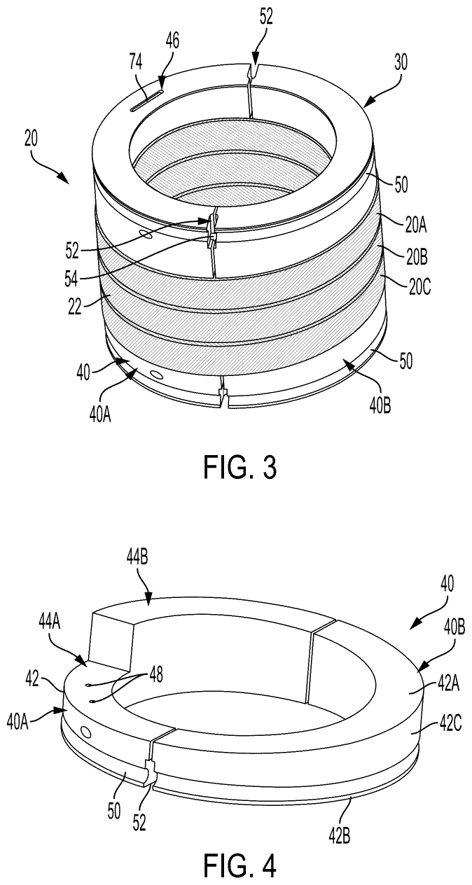

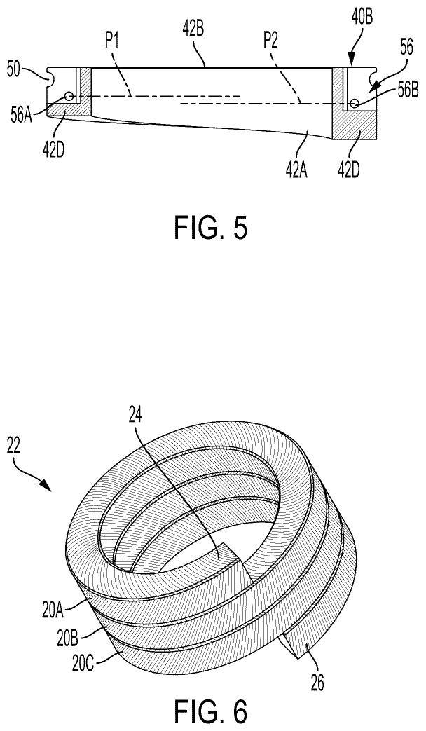

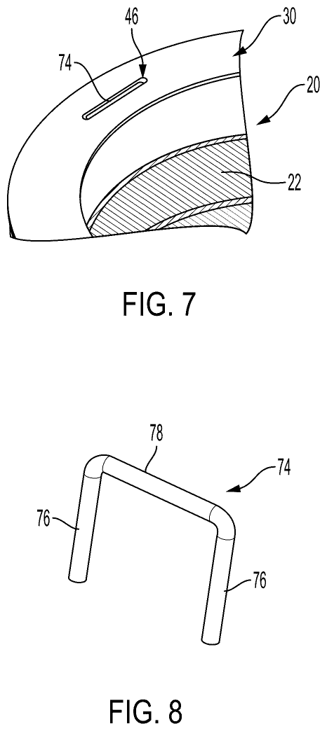

Conventional mechanical packing sealing assemblies used in conventional fluid regulating devices are usually configured to seat and mount a series of packing elements to form a packing assembly. In the present invention, as shown in FIGS. 3-7, the illustrated mechanical packing cartridge 20 can include one or more packing elements 22 that can be mounted between opposed end cap elements to form a unitized cartridge. According to one embodiment, the mechanical packing cartridge 20 can include a single spiral or helical wound packing element 22 that is disposed and captured between a pair of opposed end cap elements 30, 40. The illustrated packing element 22 can have any selected shape and size and can be cut to any selected length. The length of the packing element 22 can be selected so as to be sufficient to enable to be coiled upon itself a selected number of times to form, in essence, a packing assembly of a selected axial length or thickness. For simple purposes of illustration, the illustrated packing element 22 is wound to form a plurality of stacked coils 22A, 22B, and 22C. The packing element also includes opposed terminal ends 24 and 26. The packing element 22 can be formed in a square interbraid pattern or in any other suitable braiding pattern or shape known to those of ordinary skill in the art. The packing element 22 can be formed in a variety of cross-sectional shapes. The packing element 22 can be provided and positioned to form a seal around the shaft 12. Although the packing element 22 can employ any suitable type and shape of packing material, for the sake of simplicity, a square braid pattern is shown. The illustrated packing element 22 has a main body that has a plurality of side surfaces to form a square braid. The main body can be optionally coated with any suitable material, such as polytetrafluoroethylene (PTFE), as is known in art. One of ordinary skill in the art will readily recognize that the packing material can be formed from multiple different types of materials and can be braided in a symmetrical or asymmetrical manner relative to a lateral or horizontal axis across a cross-sectional face of the packing material.

The packing element 22 has opposed ends 24, 26 that can be coupled to the end cap elements 30 and 40, respectively, by a suitable fastener. The helical orientation and positioning of the braided packing element 22 around the shaft 12 enhances hydrodynamic lubrication and helps pump leakage fluid back into the process fluid based on the spiral orientation of the packing element 22 and the direction of shaft rotation. Various packing materials and cross sections can be used to construct the packing assembly. The illustrated cap elements 30, 40 can have an axial helical pitch that compliments the helical winding of the packing element 22. The end cap elements 30, 40 can be the same or can be differently configured. According to one embodiment, the end cap elements are the same. The end cap element 40 is shown for example in FIG. 3. Since in this embodiment the end cap elements are the same, only one end cap element needs to be described herein. The end cap element 40 can have an annular main body 42 that has a top land surface 42A that slopes in a helical manner from an axial bottom land region 44A of the top land surface to a top axially outermost land region 44B of the top land surface. The main body 42 also has a bottom surface 42B and a peripheral or circumferential outer surface 42C. The top land surface 42A can have a clockwise or counterclockwise helical pitch that extends between the land regions 44A and 44B relative to the packing element orientation and shaft rotation.

The main body 42 can also have one or more surface features formed therein for mounting or seating one or more connection or fastener elements 74. The fastener elements 74 help secure the packing element 22 to the end cap elements 30, 40. According to one embodiment, the bottom surface 42B of the end cap element 40 (shown as the top surface in end cap element 30) can have a fastener-receiving groove 46 formed therein that is sized and configured for seating the fastener element 74. The groove 46 can communicate with one or more fastener receiving openings or holes 48 that extend between the groove 46 and the top land surface 42A. The openings 48 are sized and configured for seating a respective leg portion 76 of the fastener element 74. The leg portions 76 of the fastener element 74 are coupled together via an intermediate portion 78. When the fastener element 74 is mounted within the groove 46 of the end cap element 40, a portion of the legs 76 extend past the terminal end of the openings 48 on the top land surface 42A, and hence extend axially outwardly of the top land surface 42A, and can be seated within, or pierce, the respective end portion (e.g., end portion 26) of the packing element 22. This helps secure the end portion 26 of the packing element 22 to the end cap element 40. Similarly, when the fastener element 74 is mounted within the groove 46 formed in the end cap element 30, a portion of the legs 76 extend past the terminal end of the openings 48 and can be seated within the end portion 24 of the packing element 22 so as to secure the packing element 22 to the end cap element 30. The grooves 46 and openings 48 can be precisely machined so as to ensure a snug fit for the fastener element within the groove and openings. When the fastener element 74 is inserted into the groove 46, the legs pass through the holes in the end cap elements and engage with both the groove and openings. This engagement ensures that the fastener element 74 is held firmly in place, preventing any movement or loosening during operation. The intermediate portion 78 of the fastener element forms a head portion that can be configured to sit flush with the top land surface of the end cap elements, providing a smooth and even land surface.

The packing element 22 and the end cap elements 30, 40, when coupled together, form a unitary mechanical packing cartridge 20. The mechanical packing cartridge 20 can be easily mounted and removed from the stuffing box 16 of the stationary housing 14. Moreover, the mechanical packing cartridge 20 can be easily assembled prior to installation within the stuffing box 16 of the fluid regulating device 10. Further, the fastener element 74 can be located at or along an axial center line of the top land surface 42A of the respective end cap element and the packing element 22 can be nested or seated between the end cap elements 30, 40 to form a flat sealing surface that is perpendicular to the gland element 66.

The end cap elements 30, 40 can be solid or split in any selected manner. As shown for example in FIGS. 3-5, the end cap element 40 can be split in half to form separate end cap segments 40A, 40B. The cap element 40 can also have a recessed surface feature 52 formed at an interface of the end cap segments 40A, 40B that allows the mechanical packing cartridge 20 to be removed using the extraction tool. If the end cap elements are split, then alignment pins 54 can be located at the end surfaces of one of the end cap segments 40A that can be mounted or seated in mounting holes 56 formed in the opposed end surfaces 42D, 42D of the other end cap segment 40B. The alignment pins 54 can help align and connect together the end cap segments 40A, 40B. The mounting holes 56 can be positioned such that they are offset relative to each other in an axial direction (e.g., offset in a horizontal direction relative to the bottom surface). For example, the mounting hole 56A on one end face is positioned at a first axial position, denoted by position line P1, and the mounting hole 56B on the other end face is positioned at a second different axial position, denoted by position line P2. The axial positions of the holes 56A, 56B are offset relative to each other. The offset position of the holes 56 ensures that there is sufficient material surrounding the pin holes, helps avoid assembly mishaps, and helps facilitates easy and repeatable installation of the end cap segments.

The main body 42 of the end cap element 40 can also have an optional circumferential groove 50 formed in the outer side surface 42C. The circumferential groove 50 can be sized and configured for seating or engaging with the extraction tool (not shown). The extraction tool can be used by a user to help remove the mechanical packing cartridge 20 from the stuffing box 16 of the fluid regulating device 10. The extraction tool can be provided as a separate instrument or as part of a service or maintenance kit. The extraction tool can take various forms depending on the geometry and design of the mechanical packing cartridge 20. For example, one type of extraction tool can include one or more integrated or embedded engagement features, such as a collet or gripper, that can be configured to engage with the groove 50. An axial or radial force can be applied to the extraction tool so as to remove the cartridge 20, or any portion thereof, from the stuffing box 16.

In certain fluid regulating devices, such as valves, pumps, or actuators, a lantern ring can be employed to provide a fluid communication path between an external fluid source, such as a flushing or lubrication supply, and the internal surface of the shaft 12. The lantern ring helps facilitate the supply of a lubricating or flushing fluid to reduce friction between the mechanical packing cartridge 20 and the movable shaft 12. The introduction of the fluid helps dissipate heat generated during operation, helps exclude contaminants from the process environment, and enabling leak detection in certain sealing configurations. According to one embodiment, one or more of the end cap elements 30, 40 can have a bottom or lower portion that is configured to have a selected groove or channel formed directly therein to perform the same or similar function as a lantern ring. The groove can be located along the outer diameter, inner diameter, or both. When the mechanical packing cartridge 20 is installed in the stuffing box 16, the groove can be aligned with the flush port inlet 68 to form a circumferential flow path that distributes flushing or lubricating fluid from the port 68 uniformly around the shaft 12. This integrated design can replicate the performance of a separate lantern ring while simplifying design and assembly, reducing part count, and improving fluid dynamics by minimizing turbulence and dead zones. According to one embodiment, the provided groove can be configured to perform the function of the lantern ring, shown for example as groove 51. As shown for example in FIGS. 1 and 2, the illustrated groove 51 can be formed on the outer surface of the end cap element, the inner surface of the end cap element, or both (as shown) and can be sized and dimensioned to circumferentially distribute the fluid received from the flush port inlet 68 around the shaft 12.

The illustrated mechanical packing cartridge 20 can have two selected operating configurations. The operating configuration can include a first operating configuration where the orientation of the packing element 22 is disposed opposite to the rotation of the shaft 12 resulting in a pumping action on the process fluid to pump the fluid back to the process area and thus preventing excessive leakage. The operating configurations can also include a second operating configuration where the orientation of the packing element 22 is in the same direction as the shaft rotation, thus allowing for additional controlled leakage of a process fluid that is needed at higher process pressures where frictional heat generation is higher.

The selected components of the mechanical packing cartridge 20 can be assembled to form the unitary cartridge. The packing element 22 is designed to interface with the end cap elements 30, 40 in a way that forms a relatively sufficient fluid seal. For example, the packing element 22 can be cut to a selected length so as to form a selected number of coils (e.g., coils 20A-20C). The end portion 26 can be coupled or secured to the bottom region 44A of the top land surface 42A of the end cap element 40 via the fastener element 74. The main body of the packing element 22 then rides or is wound about the helical top land surface 42A and is coiled thereabout. The opposed end portion 24 is then secured to the bottom region of the top land surface of the end cap element via another fastener element 74. The securing of the packing element 22 to the end cap elements forms the mechanical packing cartridge 20. The mechanical packing cartridge 20 is then mounted within the stuffing box 16 of the fluid regulating device 10. The mechanical packing cartridge 20 can be positioned in either the first or second operating configuration depending upon whether the user wishes to enhance the pumping action of the mechanical packing cartridge 20 ro to allow additional controlled leakage of a process fluid. The mechanical packing cartridge 20 can be removed from the stuffing box 16 if service or replacement is required by use of the extraction tool.

The packing element 22 is designed to interface with the end cap elements in a way that ensures a tight seal. The top land surfaces of the end cap elements 30, 40 are helical in form and configuration. The top land surface of the end cap elements is thus formed as a helical surface, where the elevation of the surface changes progressively along the circumferential and axial direction, thereby defining a non-planar, helically sloped surface that extends around the central axis of the end cap element. This configuration imparts a ramp-like geometry to the surface, which can be characterized by a pitch angle or vertical rise per revolution or coil of the packing element 22. The top land surface can have a selected pitch or pitch angle corresponding to a vertical rise of the surface over one full rotation. The pitch can also be sloped or angled in a clockwise or counterclockwise direction as viewed from above. As the packing element 22 is compressed between the end cap elements 30, 40, the packing element rides up on the helical surfaces. This helical design helps to distribute the compressive forces evenly across the packing element 22, ensuring a uniform seal. The helical top land surfaces also help to guide the packing element 22 into the correct position, ensuring that it remains properly aligned during operation. Further, the combination of the fastener's secure engagement with the grooves and holes, and the helical top land surfaces of the end cap elements ensures that the packing element 22 is held firmly in place and provides a reliable seal. This design helps to prevent leaks and ensures the sealing and mechanical integrity of the overall assembly. Further, the grooves 50 formed in the end cap elements help with the ease of extracting the mechanical packing cartridge 20 from the stuffing box 16 as one unit compared to disassembling multiple packing rings individually as practiced in conventional sealing arrangements.

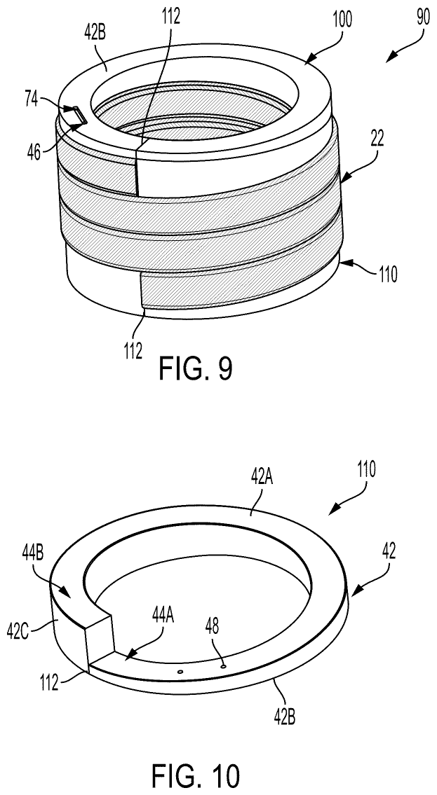

FIGS. 9 and 10 illustrate another embodiment of the mechanical packing cartridge of the present invention. Like reference numerals indicate like parts throughout the various views. The mechanical packing cartridge can employ similar end cap elements, and as such, only one end cap element needs to be described in detail. The operation of the various components are similar or the same as the components of the mechanical packing cartridge 20. For example, the mechanical packing cartridge 90 has end cap elements 100, 110. The end cap element 110 is shown in FIG. 10. The illustrated end cap element 110 can have an annular main body 42 that has a top land surface 42A that slopes in a helical manner from an axial bottom land region 44A of the top land surface to a top axially outermost land region 44B of the top land surface. The main body 42 also has a bottom surface 42B and a peripheral or circumferential outer surface 42C. The top land surface 42A can have a clockwise or counterclockwise helical pitch that extends between the land regions 44A and 44B relative to the packing element orientation and shaft rotation.

The main body 42 can also have one or more surface features formed therein for mounting or seating one or more fastener elements 74. The fastener elements 74 help secure the packing element 22 to the end cap elements 100, 110. According to one embodiment, the bottom surface 42B of the end cap element 40 (shown as the top surface in end cap element 100) can have a fastener-receiving groove 46 formed therein that is sized and configured for seating the fastener element 74. The groove 46 can communicate with one or more fastener receiving openings or holes 48 that extend between the groove 46 and the top land surface 42A. The openings 48 are sized and configured for seating a respective leg portion 76 of the fastener element 74. The leg portions 76 of the fastener element 74 are coupled together via an intermediate portion 78. When the fastener element 74 is mounted within the groove 46 of the end cap element 110, a portion of the legs 76 extend past the terminal end of the openings 48 on the top land surface 42A and hence extend axially outwardly of the top land surface 42A, and can be seated within, or pierce, the respective end portion (e.g., end portion 26) of the packing element 22. This helps secure the end portion 26 of the packing element 22 to the end cap element 110. Similarly, when the fastener element 74 is mounted within the groove 46 formed in the end cap element 100, a portion of the legs 76 extend past the terminal end of the openings 48 and can be seated within the end portion 24 of the packing element 22 so as to secure the packing element 22 to the end cap element 100.

The main body 42 can also include a split 112 at a single location so as to form a flex region that allows a user to flex or twist open the end cap element 110 at the split 112 so as to place the end cap element around the shaft 12 or to remove the end cap element therefrom. The use of a single split 112 rather than forming multiple end cap segments enables the mechanical packing cartridge 90 to employ fewer components to achieve the same result. In this embodiment, the end cap elements 110, 110 can be made from suitable flexible elastomeric materials. Further, the main body 42 can be optionally formed so as to exclude or not incorporate a lantern ring type surface feature (e.g., groove 51) or a groove 50 that operates with an extraction tool. This allows for a low profile cartridge configuration. The end cap element 100 can have a similar configuration.

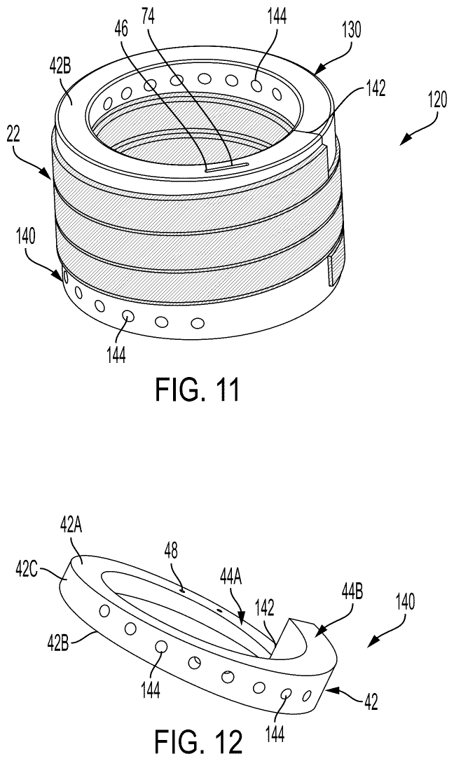

FIGS. 11 and 12 illustrate another embodiment of the mechanical packing cartridge of the present invention. Like reference numerals indicate like parts throughout the various views. The mechanical packing cartridge can employ similar end cap elements, and as such, only one end cap element needs to be described in detail. The operation and configuration of the various components is similar or the same as the components of the mechanical packing cartridges 20 and 90. For example, the mechanical packing cartridge 120 has end cap elements 130, 140. The end cap element 140 is shown in FIG. 12. The illustrated end cap element 140 can have an annular main body 42 that has a top land surface 42A that slopes in a helical manner from an axial bottom land region 44A of the top land surface to a top axially outermost land region 44B of the top land surface. The main body 42 also has a bottom surface 42B and a peripheral or circumferential outer surface 42C. The top land surface 42A can have a clockwise or counterclockwise helical pitch that extends between the land regions 44A and 44B relative to the packing element orientation and shaft rotation.

The main body 42 can also have one or more surface features formed therein for mounting or seating one or more fastener elements 74. The fastener elements 74 help secure the packing element 22 to the end cap elements 130, 140. According to one embodiment, the bottom surface 42B of the end cap element 140 (shown as the top surface in end cap element 130) can have a fastener-receiving groove 46 formed therein that is sized and configured for seating the fastener element 74. The groove 46 can communicate with one or more fastener receiving openings or holes 48 that extend between the groove 46 and the top land surface 42A. The openings 48 are sized and configured for seating a respective leg portion 76 of the fastener element 74. The leg portions 76 of the fastener element 74 are coupled together via an intermediate portion 78. When the fastener element 74 is mounted within the groove 46 of the end cap element 140, a portion of the legs 76 extend past the terminal end of the openings 48 on the top land surface 42A, and hence extend axially outwardly of the top land surface 42A, and can be seated within, or pierce, the respective end portion (e.g., end portion 26) of the packing element 22. This helps secure the end portion 26 of the packing element 22 to the end cap element 140. Similarly, when the fastener element 74 is mounted within the groove 46 formed in the end cap element 130, a portion of the legs 76 extend past the terminal end of the openings 48 and can be seated within the end portion 24 of the packing element 22 so as to secure the packing element 22 to the end cap element 130.

The main body 42 can also include a split 142 at a single location so as to form a flex region that allows a user to flex or twist open the end cap element 140 at the split 142 so as to place the end cap element around the shaft 12 or to remove the end cap element therefrom. The use of a single split 142 rather than forming multiple end cap segments enables the mechanical packing cartridge 120 to employ fewer components to achieve the same result. In this embodiment, the end cap elements 130, 140 can be made from suitable flexible elastomeric materials. Further, the main body 42 can be optionally formed so as to exclude or not incorporate a groove 50 that operates with an extraction tool. This allows for a low profile cartridge configuration.

Further, the peripheral surface 42C of the main body 42 of the end cap element 140 can have a plurality of radially spaced apart perforations or openings 144 formed therein. The openings 144 can be in fluid communication with the flush port inlet 68 so as to allow the external fluid to be communicated via the openings 144 with the shaft 12. As such, the openings 144 can provide a lantern ring effect without requiring a separate lantern ring element. The end cap element 130 can have a similar configuration.

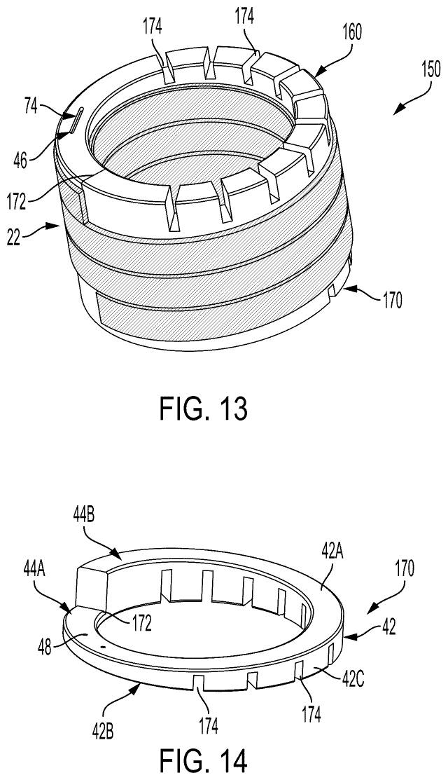

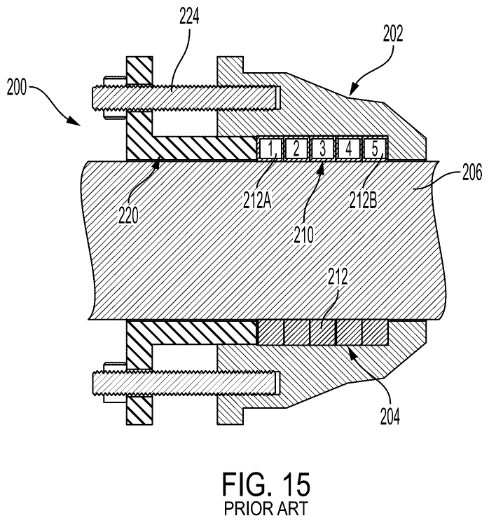

FIGS. 13 and 14 illustrate another embodiment of the mechanical packing cartridge of the present invention. Like reference numerals indicate like parts throughout the various views. The operation and configuration of the various components is similar or the same as the components of the mechanical packing cartridges 20, 90, and 120. For example, the mechanical packing cartridge 150 has end cap elements 160, 170. The end cap element 170 is shown in FIG. 14. The illustrated end cap element 170 can have an annular main body 42 that has a top land surface 42A that slopes in a helical manner from an axial bottom land region 44A of the top land surface to a top axially outermost land region 44B of the top land surface. The main body 42 also has a bottom surface 42B and a peripheral or circumferential outer surface 42C. The top land surface 42A can have a clockwise or counterclockwise helical pitch that extends between the land regions 44A and 44B relative to the packing element orientation and shaft rotation.

The main body 42 can also have one or more surface features formed therein for mounting or seating one or more fastener elements 74. The fastener elements 74 help secure the packing element 22 to the end cap elements 130, 140. According to one embodiment, the bottom surface 42B of the end cap element 140 (shown as the top surface in end cap element 160) can have a fastener-receiving groove 46 formed therein that is sized and configured for seating the fastener element 74. The groove 46 can communicate with one or more fastener receiving openings or holes 48 that extend between the groove 46 and the top land surface 42A. The openings 48 are sized and configured for seating a respective leg portion 76 of the fastener element 74. The leg portions 76 of the fastener element 74 are coupled together via an intermediate portion 78. When the fastener element 74 is mounted within the groove 46 of the end cap element 170, a portion of the legs 76 extends past the terminal end of the openings 48 on the top land surface 42A and hence extends axially outwardly of the top land surface 42A, and can be seated within, or pierce, the respective end portion (e.g., end portion 26) of the packing element 22. This helps secure the end portion 26 of the packing element 22 to the end cap element 170. Similarly, when the fastener element 74 is mounted within the groove 46 formed in the end cap element 160, a portion of the legs 76 extends past the terminal end of the openings 48 and can be seated within the end portion 24 of the packing element 22 so as to secure the packing element 22 to the end cap element 160.

The main body 42 can also include a split 172 at a single location so as to form a flex region that allows a user to flex or twist open the end cap element 170 at the split 172 so as to place the end cap element around the shaft 12 or to remove the end cap element therefrom. The use of a single split 172 rather than forming multiple end cap segments enables the mechanical packing cartridge 150 to employ fewer components to achieve the same result. In this embodiment, the end cap elements 160, 170 can be made from suitable flexible elastomeric materials. Further, the main body 42 can be optionally formed so as to exclude or not incorporate a lantern ring type surface feature (e.g., groove 51) or a groove 50 that operates with an extraction tool. This allows for low profile cartridge configuration.

Further, the bottom surface 42B of the main body 42 of the end cap element 170 (e.g., also illustrated as the axially outer surface of the end cap element 160) can have a plurality of radially spaced apart openings or slits 174 formed therein. The slits 174 allow for added flexibility in the main body 42 when twisting the main body at the split 172 and when twisting the end cap to slide the end cap over the shaft. The depth of the slits 174 in the bottom surface 42B can be configured so as to provide a symmetrical thickness of the main boy that follows the helical pitch of the top land surface 42A. The end cap element 160 can have a similar configuration.

According to another embodiment, those of ordinary skill in the art will readily recognize that the mechanical packing cartridge of the present invention can mix and match the various end cap elements described herein according to the needs of the user. The end cap elements described herein can be formed from the same material or from different materials. Examples of suitable types of material can include metals, such as bronze, plastic material, elastomeric material, and the like. Further, as described herein, the end cap elements can optionally include one or more surface features or can be configured to function or operate, during use, to have a lantern ring type of effect. This effect allows for external fluid or lubrication to control heat generation within the stuffing box 16 and can be formed integral with either or both of the end cap elements. The mechanical packing cartridge of the present invention can operate with bottom flush type stuffing boxes and other modified gland type flushing arrangements.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

We claim:

1. A mechanical packing cartridge for use with a fluid regulating device to provide a seal between a movable shaft and a stationary housing of the fluid regulating device, comprising
a packing element having a length sufficient to be coiled a selected number of times and having a first end and a second end,
a first end cap element having a main body having a first top land surface formed in a sloped helical shape for coupling to the first end of the packing element, and
a second end cap element having a second top land surface formed in a sloped helical shape for coupling to the second end of the packing element.

2. The mechanical packing cartridge of claim 1, wherein the main body of first end cap element has a first fastener opening formed therein that is sized and configured for seating a first fastener element for securing the first end of the packing element to the first top land surface, and wherein the main body of second end cap element has a second fastener opening formed therein that is sized and configured for seating a second fastener element for securing the second end of the packing element to the second top land surface.

3. The mechanical packing cartridge of claim 2, wherein the main body of the first end cap element has a split formed therein to form a first flex region, wherein the first flex region enables the first end cap element to be mounted about the shaft, and wherein the main body of the second end cap element has a split formed therein to form a second flex region, wherein the second flex region enables the second end cap element to be mounted about the shaft.

4. The mechanical packing cartridge of claim 3, wherein the main body of the first end cap element has a side surface, and wherein the side surface has a plurality of fluid openings formed therein that are sized and configured for passing a fluid therethrough.

5. The mechanical packing cartridge of claim 3, wherein the main body of the first end cap element has a bottom surface, and wherein the bottom surface has a plurality of spaced apart slits formed therein for providing flexibility to the main body.

6. The mechanical packing cartridge of claim 3, wherein the main body of the first end cap element has a side surface, and wherein the side surface has an annular groove formed therein that is sized and configured for engaging with an extraction tool.

7. The mechanical packing element of claim 1, wherein the main body of each of the first and second end cap elements has:
a groove formed in the top land surface that is sized and configured for mounting a fastener element, and
a pair of openings formed in the top land surface that extends through the main body to a bottom surface of the main body.

8. The mechanical packing cartridge of claim 1, wherein the first end cap element is differently configured than the second end cap element.

9. The mechanical packing cartridge of claim 1, whereon one of the first end cap element and the second end cap element has a groove formed in a side surface thereof that is sized and configured to provide a lantern ring effect.
